(19) United States
(12) Patent Application Publication
(10) Pub. No.: US 2004/0225818 A1
(43) Pub. Date: Nov. 11, 2004

(54) Programming control thru USB-wireless adaptor

(76) Inventor: Hsu Han, Hsin-Tien City (TW)

Correspondence Address: BACON & THOMAS, PLLC, 625 SLATERS LANE, FOURTH FLOOR, ALEXANDRIA, VA, 22314

(21) Appl. No.: 09/912,300

(22) Filed: Jul. 26, 2001

(30) Foreign Application Priority Data
Aug. 1, 2000 (TW) 89115453

(51) Int. Cl. G06F 13/38; G06F 13/40

(52) U.S. Cl. 710/305

(57) ABSTRACT

An USB-wireless adaptor using an USB protocol to communicate a signal thereby includes a wireless communication module and an I/O module. The wireless communication module has a first USB SIE(Serial bus Interface Engine) for communicating the signal by connecting to an USB cable of a control center. The I/O module has a microprocessor and a second USB SIE for communicating the signal by connecting to the USB cable. A control method of the Programming Control thru USB-wireless adaptor is involved for controlling single or multiple AP (Access Point). The control method is able to define an AP define table having single or multiple control objects according to the AP characteristic. Based on the control requirement, the control method can put one or plurality control objects into a running table. An user can modify the AP parameter by using AP define table and a procedure design tool is utilized for connecting and controlling the logical relationship among each AP, and executing the running table for managing the control process of the multiple AP.

### FIELD OF THE INVENTION

The present invention is related to a Programming Control thru USB-wireless adaptor for multiple AP (Access Point) control with the advantage of wireless communication and USB characteristic.

### BACKGROUND OF THE INVENTION

The USB interface is used to transmit a signal by way of differential amplification and has the properties of high speed transmission and cascade for multi-point, so it's application is quite general. Usually the computers or the peripherals supporting the USB interface can be connected with an USB cable. So long as a peripheral device connects to the USB cable, it may be sure that the peripheral device can connect to other peripherals or other computers for signal or data transmission. The high speed of USB version 1.1 speeds to 12 Mbps, and the USB version 2.0 speeds up to 480 Mbps. Therefore, the USB interface certainly becomes a main stream in the interface of computer products. No matter how improvement a PC or a notebook is developed, it is necessary that handheld devices are required the USB port.

A traditional USB adaptor, which combines the USB interface, a microprocessor and an I/O port (for example RS-232) has been proposed for connecting all kinds of peripheral devices with USB ports. All kinds of peripheral can easily been connected together by the traditional USB adaptor, but the traditional USB adaptor is always dominated by wired circumstances. It is useless to connect a long distance peripheral device.

From a different aspect, a wireless LAN (Local Area Network) can be used in a room or a building for communicating the long distance peripheral devices, but the cost is expensive to connect the short distance peripherals. Furthermore, the wireless LAN has the demand of the bandwidth. In wireless LAN, too many peripheral devices will make the used bandwidth narrow because of data conflict on the air, so a certain amount of peripheral devices is demanded.

Secondly, there are many APs (Access Points) on a production line for the application of industrial control. All APs always adopt the wired way to get a signal or execute a command. This will harass an user in wiring and maintaining. When an AP is failed, the user must check the system overall in order to find the fault point.

### SUMMARY OF THE INVENTION

An object of the present invention is to provide an USB wireless adaptor for wireless and wired circumstances.

Another object of the present invention is to provide the USB wireless for avoiding an issue of wiring and maintaining.

Another object of the present invention is to provide a control method for designing the control flow easily.

According to the present invention, an USB-wireless adaptor comprising: a wireless communication module having a first serial bus interface engine (SIE) adapted to make said wireless communication module to transmit a wireless signal; and an input-output (I/O) module having a microprocessor and a second serial bus interface engine (SIE) electrically connected to said first serial bus interface engine (SIE) to transmit a wired signal.

In accordance with one aspect of the present invention, the wired signal is transmitted with an universal serial bus.

In accordance with one aspect of the present invention, the universal serial bus is adapted for electrically connecting to another wireless communication module.

In accordance with one aspect of the present invention, the universal serial bus is adapted for electrically connecting to another input-output module.

In accordance with one aspect of the present invention, the input-output module comprises a RS-232 RS422 and RS485 transceiver.

In accordance with one aspect of the present invention, the wireless communication module comprise a RF module and a base band module.

According to the present invention, a control method for an USB-wireless adaptor using to control a plurality of access points comprising steps of: generating an access points define table comprising a plurality of control objects identified by the access points according to a specification of the access points; putting the control objects into a running table according to a controlling requirement; and executing the running table for proceeding a control procedure of the access points.

In accordance with one aspect of the present invention, the specification of an access point comprise a data catalog, a data attribution, a data criteria and a transfer path.

In accordance with one aspect of the present invention, the data catalog comprise I/O, A/D and D/A.

In accordance with one aspect of the present invention, the data attribution comprise a bit number, a channel number, and a scanning time.

In accordance with one aspect of the present invention, the data criteria comprises a working condition of the access point.

An AP data catalog have several kinds. In the aspect of the DAC, the spec. to determine the quality of an output signal have settling time, slew rate, the resolution, etc. In the aspect of the digital I/O, that include useable digital lines, the acceptable speed of those digital lines, the source of the digital data, the driving ability ,etc. The basis spec. of the DAQ product have the sampling channels, the sampling rate, the resolution, the input range, etc. Additionally, the counter have three kinds of signal. They are gate, source and output respectively. One can design the relative object according to the property of an AP.

The present invention may best be understood through the following description with reference to the accompanying drawings, in which:

### BRIEF DESCRIPTION OF THE DRAWINGS

FIG. 1 is a hardware architecture diagram according to the present invention;

FIG. 2 is an industrial control system schematic diagram according to the present invention;

FIG. 3 is a control method schematic diagram according to the present invention; and

FIG. 4 is a control example according to the present invention.

### DETAILED DESCRIPTION OF THE PREFERRED EMBODIMENT

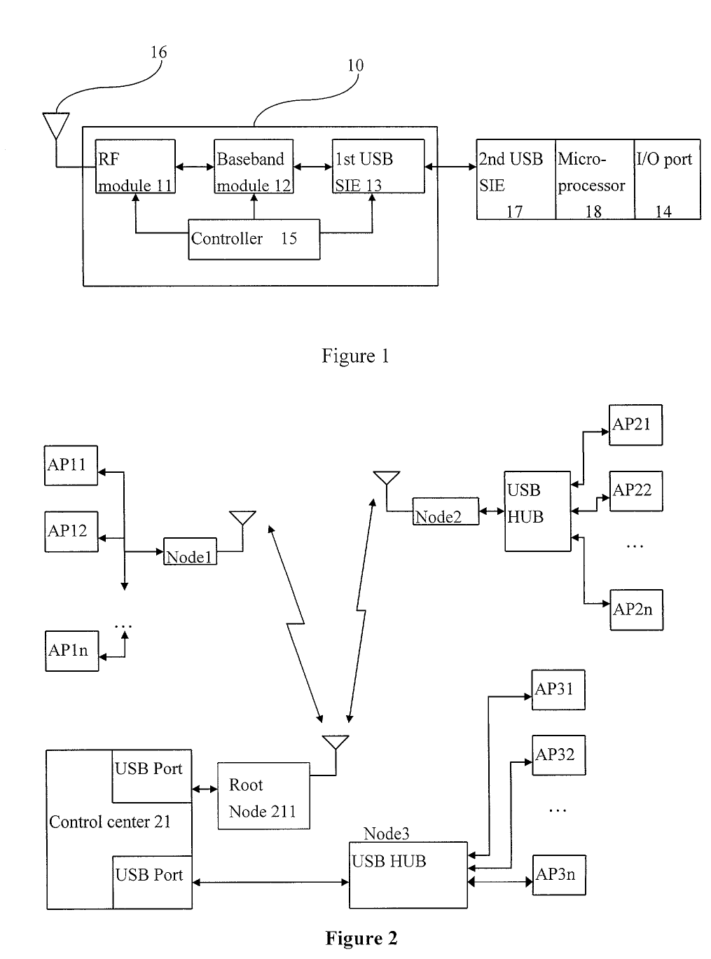

Please refer to FIG. 1 showing the hardware architecture of the USB-wireless adaptor, wherein the wireless communication module include the RF module 11, the base band module 12, the first serial bus interface engine (SIE) 13 of USB ,and the controller 15 and the input-output (I/O) module include the second SIE 17, the microprocessor 18 and the I/O port 14. The wireless signal is transmitted and received from the antenna 16. For the receiving procedure, the wireless signal is processed by the RF module 11, and the signal frequency descends to the base band since the base band module. However, the base band signal can be transferred into the signal meeting the requirement of USB. The first SIE 13 of USB will output the signal. In another aspect, the second SIE 17 of the I/O module can receive the signal to the microprocessor 18 and I/O port 14 for outputting to an other peripheral devices not supported by USB. In the present invention, wireless communication modules and I/O ports are combined with USB so the Programming Control thru USB-wireless adaptor can easily be applied in a single or a multiple access point (AP) control. Furthermore, The installation may be simple because USB has the property of PnP (Plug and Play).

In the aspect of long distance control, the property of wireless communication of USB-wireless adaptor may be utilized for connecting to the far AP. Thus some bothers in the wiring and the maintaining may be saved. The advantage is quite obvious in the industrial control for example a production line control.

FIG. 2 shows an embodiment using industrial control of the present invention. Node 1 and Node 2 are both the Programming Control thru USB-wireless adaptor of the present invention for combining the long distance access points (AP11,AP12, . . . AP1n, AP21,AP22, . . . AP2n) together. Node 3 is a wired communication module used to control AP31, AP32, . . . APn near around the control center 21. The wireless signal can be transmitted to each Node (a control group) or the control center 21 through the root note 211 of the USB-wireless adaptor. The control center 21 can consort with the job of each AP in the middle or monitor the status of each AP. Each node have many APs, and each AP may includes one I/O module. Each AP can transmit a wireless signal to the control center 21 by wireless communication module of Programming Control thru USB-wireless adaptor, and can mutually connect to another one in a control group by USB.

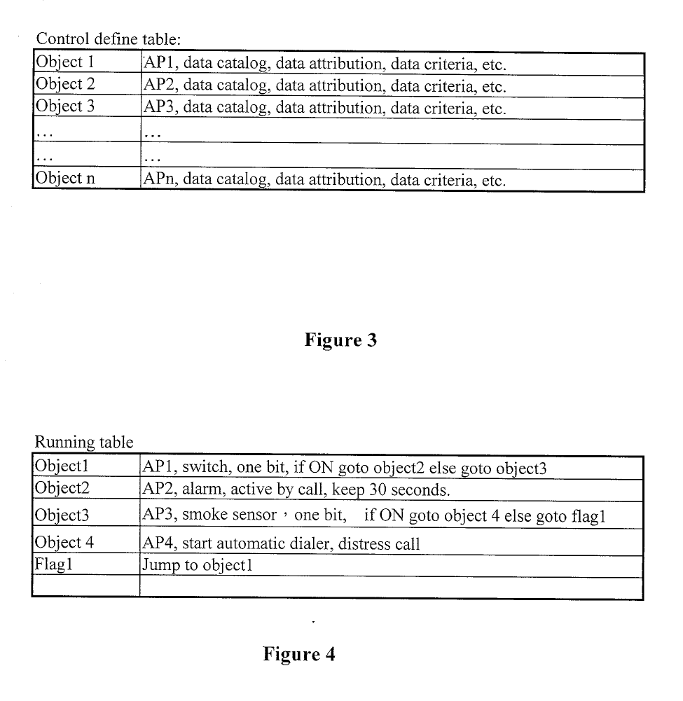

FIG. 3 shows a control method of the present invention. The control define table generates from an AP table tool. It is used to define objects. Each object include an AP and the AP's data catalog, data attribute, data criteria and transferring path. For example, if an AP is a 8 bits I/O, the AP can be defined as the data catalog is I/O; the data attribute is 8 bits; and the data criteria depends on the working condition such as action at one condition and inaction at another condition.

Depending on the arrangement of an object's relative data catalog, data attribute, data criteria and transferring path, one can define the possible working modes of each AP and one and one objects will be made.

Next, several or many objects can be used in the control flow. For example, the object1 to object4 can be added into the running table. When the running table is established, the control system may run the control flow according the working mode defined in the objects.

FIG. 4 shows a control example of the present invention. For example a control system include four access points (APs) such as a window switch, an alarm, a smoke sensor, and an automatic dialer. Each AP may be established an object. The contents of object1 shows the AP1 as the data catalog is a window switch; the data attribution is one bit; the data criteria is that if the window switch ON then go to object2. The object2 indicates AP2 as the data catalog is an alarm; the data attribution is active by call; the data criteria is to work 30 seconds. The object3 depicts AP3 as the data catalog is a smoke sensor as a switch, the data criteria is that if the smoke sensor ON then go to object4; the object4 describes that the AP4 is an automatic dialer defaulted with a telephone number; when object 3 is ON then makes the automatic dialer call the telephone number for a distress call. The Flag1 illustrates a designer can design an event by way of transferring path according to the physical status.

In the running table, a procedure design tool is provided for producing the object1 to object4. Then when the control system is to be running, the working procedure are: the object1 detects the window switch; if the window switch is ON, then start the alarm of the object2 for calling 30 seconds; if OFF, then skip to object3 state; then the object3 detects the status of the smoke sensor; if ON then start the automatic dialer for a distress call; if OFF then go to flag1 for jumping to object1 repeatedly.

In the control method of the present invention, the working modes of each AP can previously be defined. In the usage, so long as one knows some basic knowledge to use, he can install a control flow as easy as installing a bulb, and needn't write a mass of programs again. Furthermore, the control method of present invention can implement with the hardware architecture of FIG. 1 and FIG. 2 to get the advantage of USB in data transmission.

The advantages of the present invention have:

1. The wireless single and multiple access points (APs) can be constructed easily.

2. The installation and maintenance will be easy to go along.

3. The large cost will be saved when utilizing in the industrial control.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An USB-wireless adaptor comprising:
a wireless communication module having a first serial bus interface engine (SIE) adapted to make said wireless communication module to transmit a wireless signal; and
an input-output (I/O) module having a microprocessor and a second serial bus interface engine (SIE) electrically connected to said first serial bus interface engine (SIE) to transmit a wired signal.

2. An USB-wireless adaptor according to claim 1 wherein said wired signal is transmitted with an universal serial bus.

3. An USB-wireless adaptor according to claim 2 wherein said universal serial bus is adapted for electrically connecting to another wireless communication module.

4. An USB-wireless adaptor according to claim 2 wherein said universal serial bus is adapted for electrically connecting to a microprocessor of another input-output module.

5. An USB-wireless adaptor according to claim 1 wherein said input-output module comprises a RS-232, RS422 and RS485 transceiver.

6. An USB-wireless adaptor according to claim 1 wherein said wireless communication module comprise a RF module and a base band module.

7. A control method for controlling a plurality of access points of USB wireless adaptors having a property of plug and play (PnP) comprising steps of:
generating an access points define table comprising a plurality of control objects identified by said access points according to a specification of said access points;
putting said control objects into a running table according to a controlling requirement; and
executing said running table for proceeding a control procedure of said access points.

8. A control method for said USB-wireless adaptor according to claim 7 wherein said specification of as access point comprise a data catalog, a data attribution, a data criteria and a transfer path.

9. A control method for said USB-wireless adaptor according to claim 8 wherein said data catalog comprise I/O, A/D and D/A.

10. A control method for said USB-wireless adaptor according to claim 8 wherein said data attribution comprise a bit number, a channel number, and a scanning time.

11. A control method for said USB-wireless adaptor according to claim 8 wherein said data criteria comprises a working condition of said access point.
